(19) United States
(12) Patent Application Publication
(10) Pub. No.: US 2015/0017278 A1
(43) Pub. Date: Jan. 15, 2015

(54) METHOD FOR WEIGHT LOSS AND MANAGEMENT AND HERBAL COMPOSITION FOR ACHIEVING THE SAME

(71) Applicant: Carlton R. Branker, Pembrooke Pines, FL (US)

(72) Inventor: Carlton R. Branker, Pembrooke Pines, FL (US)

(21) Appl. No.: 14/272,129

(22) Filed: May 7, 2014

Related U.S. Application Data
(60) Provisional application No. 61/844,391, filed on Jul. 9, 2013.

(51) Int. Cl. A23F 5/24; A23F 5/02

(52) U.S. Cl. CPC A23F 5/24; A23F 5/02
USPC 426/2; 426/594; 426/595

(57) ABSTRACT

A natural formulation and associated method promotes fat and weight loss while decreasing food cravings, boosting metabolic rate, and supporting the immune system. An instant coffee blend is provided to aid in the delivery of such a composition. The coffee is made from a premixed herbal formula that is combined with herbal extracts. The premixed herbal formula includes one or more, or all, of the following active ingredients: green coffee bean extract, green tea extract, ginseng root, chromium, garcinia cambogia, yerba mate leaf, raspberry ketones, banaba leaf extract, hoodia gordoni cactus, griffonia simplicfolia, amorphophallus konjac, capscium fruit, glucomannan, and yohimbine. The premixed formula is added to the instant coffee based that may include a special blend of green coffee bean extract, natural color, natural flavorings, and artificial flavorings.

### CROSS-REFERENCE TO RELATED APPLICATION

This application claims the benefit of priority of U.S. provisional application No. 61/844,391, filed Jul. 9, 2013, the contents of which are herein incorporated by reference.

### BACKGROUND OF THE INVENTION

The present invention relates to weight loss and weight management compositions and methods and, more particularly, to an instant coffee blend and method of promoting weight loss while decreasing food cravings and boosting metabolic rate. The coffee can be made from a pre-mixed formula which includes one or more of the following active ingredients: green coffee bean extract, green tea extract, ginseng root, chromium, garcinia cambogia, yerba mate leaf, raspberry ketones, banaba leaf extract, hoodia gordoni cactus, griffonia simplicfolia, amorphophallus konjac, capsicum fruit, glucomannan, and yohimbine.

Approximately, 97 million Americans, or about 61 percent, are overweight or obese. Many current weight lose strategies require significant limitations on the amount of caloric intake and/or increase in metabolizing the current caloric intake or stored fat which is generally done through aerobic exercise to achieve weight loss. While these are effective strategies for weight loss, many people find it difficult to start an exercise regimen and continue with reduced caloric intake. Furthermore, many adults consume coffee, typically at least one cup of coffee a day.

There is a need for a weight control that is convenient for the user. The method should actively promote fat and weight reduction without significant side effects. There is also a need to naturally reduce the users urge to over eat while presenting it in a simple form of instant coffee which is convenient and easy to use.

### SUMMARY OF THE INVENTION

The present invention relates to a method for promoting fat and weight loss. This method also helps increase lean muscle mass in the individual user. More particularly, the invention relates to co administration of green coffee bean extract, green tea extract, ginseng root, chromium, garcinia cambogia, yerba mate leaf, raspberry ketones, banaba leaf extract, hoodia gordoni cactus, griffonia simplicfolia, amorphophallus konjac, capscium fruit, saffron extract, glucomannan, yohimbine, in the form of an instant coffee.

In one aspect of the present invention, a weight loss formulation comprises an instant coffee; and green coffee bean extract.

In another aspect of the present invention, a method for losing weight comprises administering an effective amount of a weight loss formulation to a patient in need thereof, the weight loss formulation including an instant coffee and a green coffee bean extract.

In a further aspect of the present invention, a weight loss formulation comprises green coffee bean extract; and a coffee drink having the green coffee been extract therein.

These and other features, aspects and advantages of the present invention will become better understood with reference to the following description and claims.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a natural formulation and associated method of promoting fat and weight loss while decreasing food cravings, boosting metabolic rate, and supporting the immune system. According to at least one aspect of the present invention, an instant coffee blend is provided to aid in the delivery. The coffee is made from a premixed herbal formula that is combined with herbal extracts. The premixed herbal formula includes one or more (or all) the following active ingredients: green coffee bean extract, green tea extract, ginseng root, chromium, garcinia cambogia, yerba mate leaf, raspberry ketones, banaba leaf extract, hoodia gordoni cactus, griffonia simplicfolia, amorphophallus konjac, capscium fruit, glucomannan, and yohimbine. The premixed formula is added to the instant coffee based that may include a special blend of green coffee bean extract, natural color, natural flavorings, and artificial flavorings.

The formulation of the present invention can be provided, for example, in a pre-measured packet, in a solid form for dissolution in an aqueous medium, such as hot water. The formulation and include instant coffee to provide the base for the coffee drink. The instant coffee may be regular (caffeinated) instant coffee or may be provided as a decaffeinated instant coffee.

In addition to being provided as an instant coffee, the agent could be provided in a water drink or whey protein shake. Additionally, the agent could be provided in pill or capsule form.

The present invention also provides a diet method wherein the agent is ingested as a cup of coffee with or without milk, cream, and/or sugar (sweeteners) once or more daily. This can be performed, for example, 30 minutes before eating breakfast, lunch, and/or dinner. The diet can also require that certain foods be eaten as a part of a balanced meal including fresh fruits, protein, vegetables.

In some embodiments of the present invention, a method for promoting weight and fat loss in an individual in need thereof, comprises co-administration, to the individual, a daily effective weight and fat loss promoting amounts of one or more of green coffee bean extract, green tea extract, ginseng root, chromium, garcinia cambogia, yerba mate leaf, raspberry ketones, banaba leaf extract, hoodia gordoni cactus, griffonia simplicfolia, amorphophallus konjac, saffron extract, capscium fruit, glucomannan, and yohimbine.

In some embodiments, the coffee drink formulation of the present invention includes an instant coffee with a green coffee bean extract. The formulation of the present invention can preserve the essential health benefits of the unroasted green coffee bean while providing the balance of rich coffee flavor and the convenience of an instant coffee drink. The green coffee bean extract can be supplemented with one or more of raspberry ketone, amorphophallus konjac, and green tea extract. The formulation can also be supplemented with one or more of ginseng root, chromium, garcinia cambogia, yerba mate leaf, banaba leaf extract, hoodia gordoni cactus, griffonia simplicfolia, saffron extract, capscium fruit, glucomannan, and yohimbine.

In some embodiments, the effective amount of green coffee bean extract is between about 5 mg and 5 grams. In some embodiments, the effective amount of green tea extract is between about 5 mg and 5 grams. In some embodiments, the effective amount of chromium is between about 5 mg and 200 mg. In some embodiments, the effective amount of banaba leaf extract is between about 5 mg and 20 grams. In some embodiments, the effective amount of hoodia gordoni cactus is between about 5 mg and 20 grams. In some embodiments, the effective amount of vanilla extract is between about 5 mg and 20 grams. In some embodiments, the effective amount of instant Colombian and/or Brazilian coffee is between about 5 mg and 20 gram. In some embodiments, the effective amount of non-dairy powdered cream is between about 5 mg and 20 grams.

In some embodiments, the effective amount of ginseng root is between about 5 mg and 2 grams. In some embodiments, the effective amount of garcinia cambogia is between about 5 mg and 50 mg. In some embodiments, the effective amount of yerba mate leaf extract is between about 5 mg and 20 grams. In some embodiments, the effective amount of raspberry ketones is between about 5 mg and 20 grams. In some embodiments, the effective amount of griffonia simplicfolia is between about 5 mg and 5 grams. In some embodiments, the effective amount of amorphophallus konjac is between about 5 mg and 1 gram. In some embodiments, the effective amount of Calcium is between about 5 mg and 1 gram. In some embodiments, the effective amount of saffron extract is between about 5 mg and 500 mg. In some embodiments, the effective amount of capscium is between about 5 mg and 500 mg. In some embodiments, the effective amount of glucomannan is between about 5 mg and 20 grams. In some embodiments, the effective amount of yohimbine is between about 5 mg and 20 grams.

In some embodiments, the components of green coffee bean extract, green tea extract, ginseng root, chromium, garcinia cambogia, yerba mate leaf, raspberry ketones, banaba leaf extract, hoodia gordoni cactus, griffonia simplicfolia, amorphophallus konjac, saffron extract, capscium fruit, glucomannan, and yohimbine, can be present in from about 750 mg to about 800 mg in a 10 gram serving. Other ingredients can include various flavors, preservatives, a non-dairy creamer and the like.

The composition of the present invention provides a coffee drink that includes one or more supplements that can promote weight loss, reduce cravings, increase energy, burn excess body fat, and can include antioxidants. While the above provides a specific set of supplements present in the coffee drink, one or more of these supplements may be present along with other supplements, for example.

By providing weight loss supplements in a coffee drink, the present invention can be easily incorporated into a daily routine of an individual. Many people drink one or more cups of coffee a day. Therefore, by substituting one cup of regular coffee with the coffee formulation of the present invention, a user can easily and effectively receive the benefits of the formulation of the present invention with little or no disruption of one's daily routine. Many supplements in pill form, for example, require the user to remember to get and take the pill each day. If the user is not a daily pill taker, this can be a significant change from their daily routine. The coffee drink of the present invention does not require these changes from one's daily routine.

It should be understood, of course, that the foregoing relates to exemplary embodiments of the invention and that modifications may be made without departing from the spirit and scope of the invention as set forth in the following claims.

What is claimed is:

1. A weight loss formulation comprising:
an instant coffee; and
green coffee bean extract.

2. The weight loss formulation of claim 1, further comprising at least one of raspberry ketone, amorphophallus konjac, and green tea.

3. The weight loss formulation of claim 1, further comprising raspberry ketone, amorphophallus konjac, and green tea.

4. The weight loss formulation of claim 2, further comprising at least one of ginseng root, chromium, garcinia cambogia, yerba mate leaf, banaba leaf extract, hoodia gordoni cactus, griffonia simplicfolia, saffron extract, capscium fruit, glucomannan, and yohimbine.

5. The weight loss formulation of claim 3, further comprising ginseng root, chromium, garcinia cambogia, yerba mate leaf, banaba leaf extract, hoodia gordoni cactus, griffonia simplicfolia, saffron extract, capscium fruit, glucomannan, and yohimbine.

6. The weight loss formulation of claim 1, further comprising a non-dairy creamer.

7. The weight loss formulation of claim 1, wherein the formulation is provided in a solid form for dissolution into an aqueous medium.

8. A method for losing weight comprising administering an effective amount of a weight loss formulation to a patient in need thereof, the weight loss formulation including an instant coffee and a green coffee bean extract.

9. The method of claim 8, wherein the weight loss formulation further comprises at least one of raspberry ketone, amorphophallus konjac, and green tea.

10. The method of claim 8, wherein the weight loss formulation further comprises raspberry ketone, amorphophallus konjac, and green tea.

11. The method of claim 9, wherein the weight loss formulation further comprises at least one of ginseng root, chromium, garcinia cambogia, yerba mate leaf, banaba leaf extract, hoodia gordoni cactus, griffonia simplicfolia, saffron extract, capscium fruit, glucomannan, and yohimbine.

12. The method of claim 10, wherein the weight loss formulation further comprises ginseng root, chromium, garcinia cambogia, yerba mate leaf, banaba leaf extract, hoodia gordoni cactus, griffonia simplicfolia, saffron extract, capscium fruit, glucomannan, and yohimbine.

13. The method of claim 8, wherein the weight loss formulation further comprises a non-dairy creamer.

14. The method of claim 8, further comprising dissolving the weight loss formulation as a solid form into an aqueous medium.

15. A weight loss formulation comprising:
green coffee bean extract; and
a coffee drink having the green coffee been extract therein.

16. The weight loss formulation of claim 15, further comprising at least one of raspberry ketone, amorphophallus konjac, and green tea.

17. The weight loss formulation of claim 15, further comprising raspberry ketone, amorphophallus konjac, and green tea.

18. The weight loss formulation of claim 16, further comprising at least one of ginseng root, chromium, garcinia cambogia, yerba mate leaf, banaba leaf extract, hoodia gordoni cactus, griffonia simplicfolia, saffron extract, capscium fruit, glucomannan, and yohimbine.

19. The weight loss formulation of claim 17, further comprising ginseng root, chromium, garcinia cambogia, yerba mate leaf, banaba leaf extract, hoodia gordoni cactus, griffonia simplicfolia, saffron extract, capscium fruit, glucomannan, and yohimbine.

20. The weight loss formulation of claim 15, further comprising a non-dairy creamer.
